(19) United States
(12) Patent Application Publication
(10) Pub. No.: US 2015/0026094 A1
(43) Pub. Date: Jan. 22, 2015

(54) RELIABILITY TARGET SYSTEM

(71) Applicant: Cisco Technology, Inc., San Jose, CA (US)

(72) Inventors: Graciela B. Marchevsky, Los Alto, CA (US); David Wan-Hua Hsiao, Palo Alto, CA (US); Bernard J. Favaro, JR., Kenwood, CA (US); Marc C. Bush, Morgan Hill, CA (US); Arvinder P. Singh, San Jose, CA (US); Daniel T. Howley, Campbell, CA (US); John J. Sohn, San Jose, CA (US)

(21) Appl. No.: 13/945,457

(22) Filed: Jul. 18, 2013

(51) Int. Cl. G06Q 30/02

(52) U.S. Cl. CPC G06Q 30/0282
USPC 705/347

(57) ABSTRACT

A system, such as a reliability target system (RTS), can determine a customer driven reliability target (CDRT) for a product, such as an electronic device or system. The CDRT can be a target reliability or quality score or a target value, such as a mean time between failures target value. The system may include one or more hardware modules (such as hardware modules including software) configured to: select a high availability mean time between failures (HA); determine a predicted mean time between failures (pMTBF), such as according to industry standard procedures; determine a field mean time between failures (fMTBF), such as according to historical customer experience information associated with the product and/or a product competing with the product.

### TECHNICAL FIELD

The present disclosure relates to determining reliability targets.

### BACKGROUND

Mean time between failures (MTBF) is the time between failures of a device or system. MTBF can be calculated as an arithmetic average time between failures.

Device manufactures can predict MTBF based on various MTBF prediction models. For example, the TELCORDIA SR-332 prediction procedure is model used for reliability prediction concerning electronic equipment. TELCORDIA SR-332 procedure uses what is often described as a “parts count” methodology for predicting assembly level failure rates. The procedure assigns generic component level failure rates, and sums those failure rates for components, such as components on a bill of materials; thus, giving an overall score for failure rates of a device or system.

### BRIEF DESCRIPTION OF THE DRAWINGS

FIGS. 1a, 1b, and 1c illustrate a flow chart of an example process that can be implemented by an example reliability target system (RTS) and can gather customer expectations and competitive intelligence.

FIG. 1d illustrates an example block diagram of example aspects of an example RTS utilized in the processes illustrated in FIGS. 1a, 1b, 1c.

FIG. 2 illustrates a block diagram of example aspects of a function f(x) for determining a customer driven reliability target (CDRT).

FIG. 3 illustrates a diagram of an example CDRT setting process timeline.

FIG. 4 illustrates a block diagram of an example architecture 400 for implementing an example RTS.

FIG. 5 illustrates a block diagram of an example electronic device 500 that can implement an aspect of an example RTS, such as one implemented by the architecture 400.

### DESCRIPTION OF EXAMPLE EMBODIMENTS

### Overview

In one example, a system, such as a reliability target system (RTS), can determine a customer driven reliability target (CDRT) for a product, such as an electronic device or system. The CDRT can be a target reliability or quality score or a target value, such as a mean time between failures target value. The system may include one or more hardware modules that may include software. The one or more hardware modules may be configured to: select a high availability mean time between failures (HA); determine a predicted mean time between failures (pMTBF), such as according to industry standard procedures; determine a field mean time between failures (fMTBF), such as according to historical customer experience information associated with the product and/or a product competing with the product. The historical customer experience information may include historical product performance information associated with the product and/or competing products and/or historical customer satisfaction information associated with the product and/or competing products, for example. The one or more hardware modules may be configured to determine the CDRT according to the HA, the pMTBF, and the fMTBF. The determination of the CDRT may include determining a maximum value between the HA, the pMTBF, and the fMTBF. The module(s) may also be configured to use the CDRT to determine changes to the product. Also, the module(s) may be configured to output the CDRT, such as outputting the CDRT to be displayed on a display device.

Also, the one or more hardware modules may be configured to select a customer ideal mean time between failures (customer ideal) associated with the product, and use the customer ideal to limit the maximum value of the HA, the pMTBF, and the fMTBF. In other words, in one example, the maximum is not to exceed the customer ideal.

The one or more hardware modules may also be configured to identify competitive intelligence information associated with the product. The module(s) may also be configured to determine a customer satisfaction score according to collected customer satisfaction information. The module(s) may also calibrate the CDRT using the customer satisfaction score and/or the competitive intelligence information, for example.

Alternatively, the one or more hardware modules may be configured to select a customer ideal mean time between failures (customer ideal) for the product and/or competing products, wherein the maximum value of the HA, the pMTBF, and the fMTBF is not to exceed the customer ideal. Also, the module(s) can be configured to identify customer satisfaction information associated with the product and/or competing products; identify competitive intelligence information associated with the product and/or competing products; and calibrate the CDRT using the customer satisfaction information and the competitive intelligence information.

In another example, the system may include one or more hardware modules (such as one or more hardware modules that include software) configured to collect measured customer expectation information related to performance of a product and products competing with the product. The module(s) may also be configured to determine predicted product performance information related to performance of the product and products competing with the product; and determine a CDRT according to the predicted product performance information and the measured customer expectation information. The module(s) may also be configured to use the CDRT to determine changes to the product. Also, the module(s) may be configured to output the CDRT, such as outputting the CDRT to be displayed on a display device. In such examples, additionally, the module(s) may be configured to compare the CDRT against current customer expectation information. The customer expectation information may be customer expectation information collected within a predetermined amount of time from a present time. The module(s) may also be configured to determine whether the customer driven reliability target exceeds the current customer expectation information more than a predetermined threshold. The current customer expectation information may be a mean time between failures, and the predetermined threshold may be a high availability mean time between failures. Furthermore, the measured customer expectation information may include historical customer experience information, such as historical product performance information associated with the product and historical customer satisfaction information associated with the product.

### EXAMPLE EMBODIMENTS

Various embodiments described herein can be used alone or in combination with one another. The following detailed description describes only a few of the many possible implementations of the present embodiments. For this reason, this detailed description is intended by way of illustration, and not by way of limitation.

Device producers, such as electronic device producers, may determine a predicted MTBF based on a prediction procedure, such as the TELCORDIA SR-332 prediction procedure. The SR-332 procedure uses what is often described as a “parts count” methodology for predicting assembly level failure rates. The SR-332 procedure assigns generic component level failure rates, and sums those failure rates for components, such as components on a bill of materials. Although the SR-332 procedure may be used by device producers, it does not provide a predicted target level of satisfaction for customers of the produced devices.

Many large assemblies may have thousands of components, such as 10,000 components; so in order to achieve a target of 100,000 hours in this example, MTBF would require that each component averages less than one failure in time (e.g., one failure per billion hours). It may be impractical to collect, from a supplier, evidence that the supplier's material or component achieves a failure in time (FIT) less than one. For example, suppliers may be required to show semiconductor devices may be required to demonstrate, in High Temperature Operating Life (HTOL), for example, a FIT of less than 50. Testing beyond this degree may have costs associated with it that makes such a test impractical.

Using industry standard prediction procedures, such as the SR-332 procedure, device producers may meet reliability goals that meet industry standards. However, such industry standard testing may not accurately reflect customer expectations, competitive or marketplace pressures, network availability targets, or any other type of competitive intelligence, for example. Competitive intelligence may be any known or proprietary information associated with competitive advantages relative to a product, competing products, a brand, competing brands, or the like. Competitive intelligence may also be marketplace information, in general.

Also, such standard testing may not address historical process capabilities of devices or systems tested, or account for customer feedback, such as feedback via surveys. A system, such as a reliability target system (RTS), can determine a customer driven reliability target (CDRT), which is a target score that can represent a target reliability or quality level of a product, such as a target reliability or quality rating of an electronic device or system. In one example, the CDRT can be a desired target reliability of a device or system relative to competing products. The CDRT can be influenced by customer expectations of quality for a product. Example factors for determining a CDRT are described herein in detail. In one example, the CDRT may be a mean time between failures (MTBF), such as one thousand hours between failures.

The CDRT can be used to calculate a customer driven reliability ratio (CDRR), and this calculation can resolve or at least address the aforementioned limitations of standard testing procedures, such as SR-332. The CDRR is a ratio of how well a device or system is actually performing against the CDRT. In one example, if the CDRT is 300,000 hours between failures and a Field MTBF (fMTBF) is 330,000, then the CDRR is 330,000/300,000 or 1.1. Any CDRR equal to or greater than 1.0 may indicate a device or system is meeting customer expectations, for example.

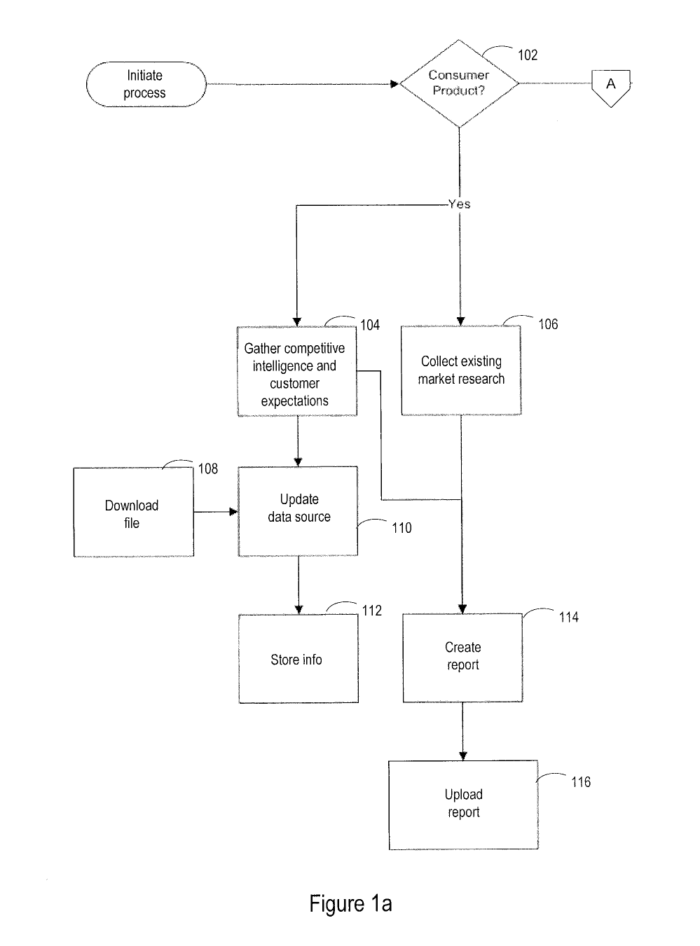

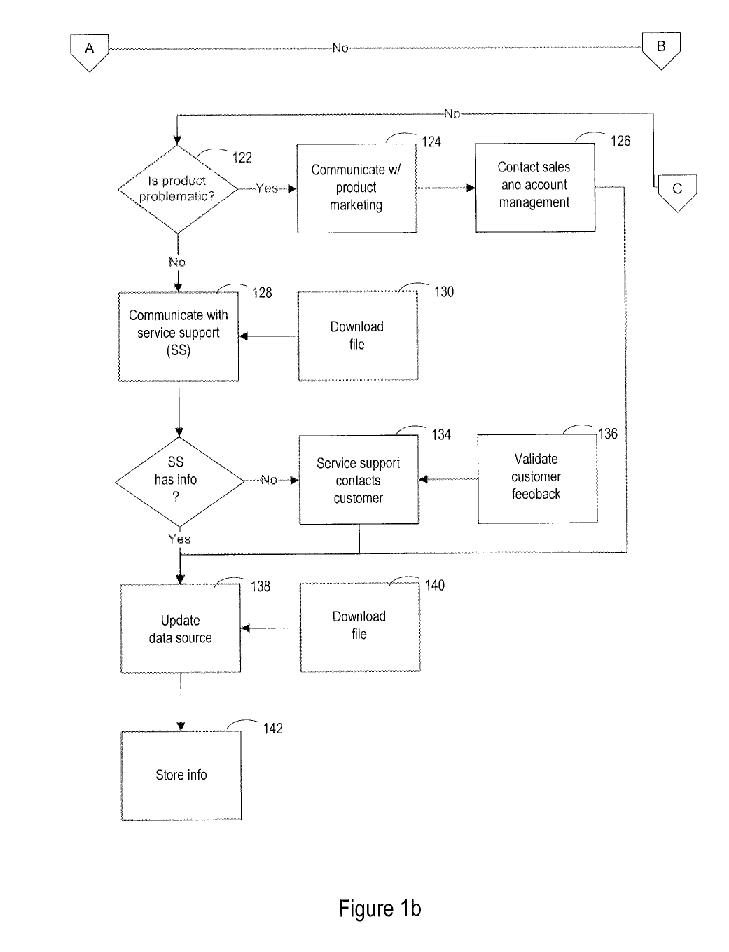

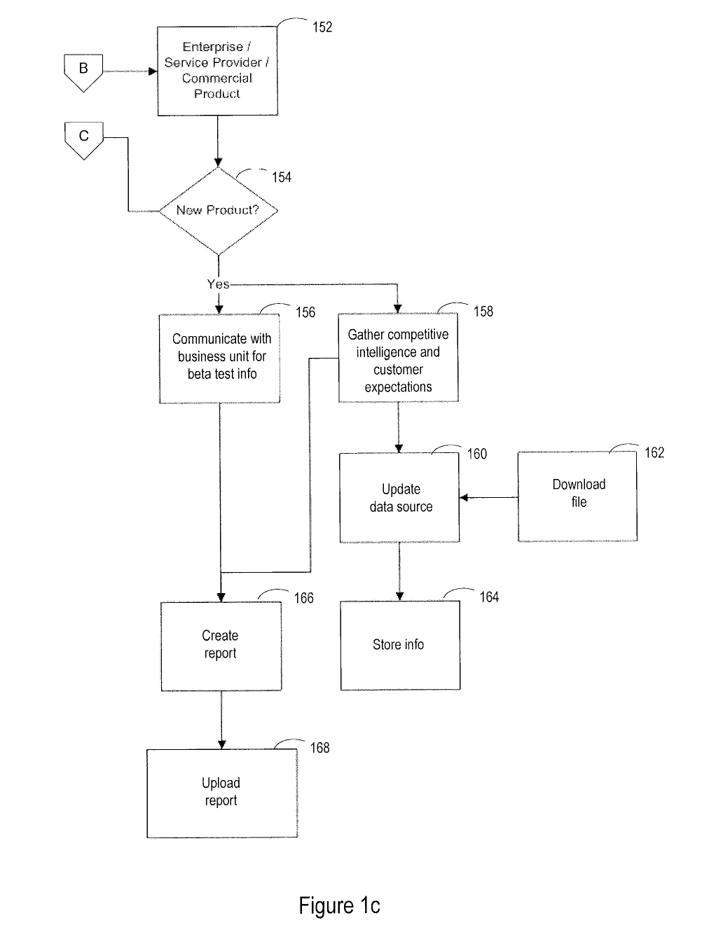

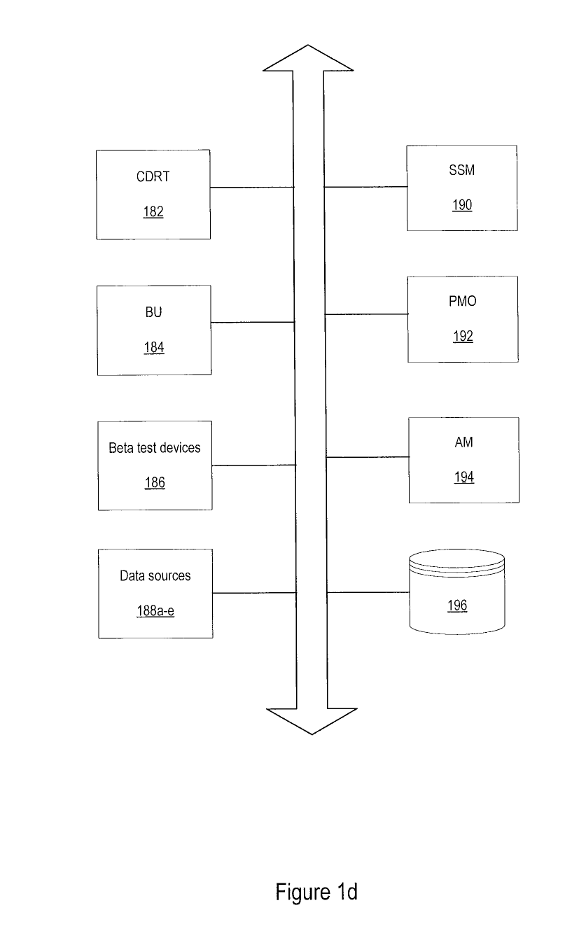

FIGS. 1a, 1b, and 1c illustrate a flow chart of an example process that can be implemented by an example RTS and can gather customer expectations and competitive intelligence, for example, via a CDRT module and/or other modules of or associated with the RTS. FIG. 1d illustrates an example block diagram of example aspects of an example RTS utilized in the processes illustrated in FIGS. 1a, 1b, and 1c.

CDRT settings, such as CDRT settings associated with determining a CDRR, may be determined by a number of variables, including customer expectations and competitive intelligence, for example. A process for collecting customer expectations and/or competitive intelligence, such as one executed by the RTS may be different for consumer products and non-consumer products. In FIG. 1a, at 102, a module of or associated with the RTS, such as the CDRT module 182, can determine whether a device or a system to be analyzed for customer expectations and competitive intelligence is a consumer product or a non-consumer product.

Where the analysis is for a consumer product, the CDRT module 182 can gather customer expectations and competitive intelligence at 104, update a corresponding data source at 110, and store such information to the corresponding data source at 112, such as a part of database 196. At 108, a file from the data source can be downloaded for the update at 110. Further, at 106, the CDRT can communicate with a server of a product marketing organization 192 and/or a business unit module 184 to collect existing market research information. This existing market research information along with the collected customer expectations and/or competitive intelligence can be input to a report at 114. Then the report can be stored to a corresponding data source at 116, such as a part of a database 196.

Where the analysis is for a non-consumer product, the CDRT module 182 can determine whether the device or system is a new product at 154. Where the product is a new product, the CDRT module 182 can gather customer expectations and competitive intelligence at 158, update a corresponding data source at 160, and store such information to the corresponding data source at 164, such as a part of the database 196. At 162, a file from the data source can be downloaded for the update at 160.

Also, where the product is a new product, the CDRT module 182 can communicate with a business unit module 184 to get beta testing information from customer surveys at 156, such as via beta test devices 186. This beta testing information along with the collected customer expectations and/or competitive intelligence can be input to a report at 166. Then the report can be stored to a corresponding data source at 168, such as a part of the database 196.

Where the product has been in the market, the actual field performance can be measured (e.g., fMTBF) and compared against a CDRT value by the CDRT module 182 and this can determine whether the device or system is problematic (such as the fMTBF/CDRT<1.0) at 122. Where the product is problematic, the CDRT can communicate with a server of a product marketing organization 192 to gather product market information regarding the product at 124; and at 126, the CDRT can communicate with servers of a product sales specialist and/or an account manager 194 to receive customer feedback and/or organize a customer interview. Once information is collected at 124 and 126, for example, a data source storing customer expectations and competitive intelligence can be updated with the information at 138, and stored at 142. At 140, a file from the data source can be downloaded for the update at 138.

Where the product is not problematic, customer expectations and competitive intelligence can still be collected. For example, at 128, the CDRT can communicate with a computer of a service support manager to gather such information, such as a service support manager module 190. At 132, it is determined whether the computer can obtain the customer expectations and competitive intelligence. Where the server of the service support manager cannot obtain such information, the service support manager may contact one or more customers at 134, and communicate with others and their systems to validate the customer feedback at 136. The information collected from the service support manager can eventually be used as input for the update at 138. Where the server of the service support manager can obtain the customer expectations and competitive intelligence automatically, such information previously collected can be updated at 138.

As explained, a process for gathering customer expectations for non-consumer products may include a CDRT module 182 communicating with a business unit module 184 to retrieve inputs from non-consumer customers (e.g., at 156). The CDRT module 182 and the business unit module 184 may be included in or associated with the RTS, as explained. Inputs from the non-consumer customers may come from beta testing devices 186 via these customers. This is especially useful for new products. The beta test may be geared towards determining customer expectations for product reliability (or AFR (Annual Failure Rate), and availability such as device or system up time. The CDRT module 182 may ensure with the business unit module 184 that a valid Non-Disclosure Agreement (NDA) is in place for testing a product, such as beta testing a device with other devices associated with a non-consumer customer. The NDA may also cover CDRT module 182 generated documents and information collected from the non-consumer customers.

A process for gathering competitive intelligence for non-consumer products (e.g., at 158 of FIG. 1c) may include a process that includes a non-consumer customer expectations survey. The non-consumer customer expectations survey may be provided by the business unit module 184. The CDRT module 182 may also perform a competitive intelligence survey. The data gathered from the CDRT module 182 may be from various resources, such as data stored by servers of the device producer 188a, data stored by servers of acquired companies 188b, partner companies 188c, or customers 188d, publically shared information (e.g., such as shared information over the Internet including competitor's web pages) 188e, data stored by servers of survey service providers, product sales specialist, and/or data from data repositories of account managers, such as account manager module 194 (e.g., see 124, 126, and 128).

A process for gathering customer expectations for consumer products may be contingent on whether there are consistent or significant reliability issues in the field. Where there are no consistent or significant field issues, the CDRT module 182 may communicate with a service support manager module 190 (such as one included in or associated with the RTS) to obtain consumer customer expectations for reliability, availability, and AFR. A service support manager module 190 may provide a name and title from whom the information was obtained. Where a service support manager module 190 has access to customer expectations, it can validate and/or document expectations of a consumer customer along with contact information of the customer. Where a service support manager module 190 does not have access to customer expectations, the service support manager module 190 may contact, automatically or via input from a user of the module, the consumer customer to obtain and document reliability, availability, and AFR expected from that customer. The service support manager module 190 can then validate and/or document expectations of the consumer. Contact of the customer can be via various communication channels having access to customer contact information.

Significant or consistent field issues are determined by several methods. For example, the CDRT module 182 may communicate with a server from a product marketing organization 192 to obtain customer names for various scenarios of testing the product. The CDRT module 182 may also communicate with a device 194, such as a computer, of an account manager or a product sales specialist, for example, to obtain feedback from an account manager or a product sales specialist for reliability, availability, and AFR. Alternatively, the CDRT may gather such information from a database 196 automatically. In one example, the database 196 can be periodically updated by an account manager or a product sales specialist.

Where an account manager or product sales specialist, for example, is unable to provide consumer customer feedback or where a database warehousing such information is not up-to-date, the CDRT module 182 may request the account manager and/or product sales specialist to arrange a consumer customer interview, survey, or roundtable. Alternatively, the database or a server communicatively coupled with the database may automatically communicate virtual interviews, surveys, or roundtables with consumer customers.

The CDRT module 182 may collect consumer and non-consumer customer expectations directly from a customer during customer interviews or may collect expectations indirectly via correlations, such as correlations derived by account manager or product sales specialist systems. In either case, customer names, titles, and other contact information may be collected to validate expectation information.

The customer expectations and competitive intelligence can be used by the system to set CDRTs. The CDRT module 182 may communicate with various servers of various entities to collect customer expectation and competitive intelligence information and the CDRT module 182 may carry out surveys, interviews, or roundtables itself, to a live audience or virtually. The various servers of various entities may include, as mentioned, servers of the device producer, servers of acquired companies, partner companies, or customers, servers hosting publically shared information (e.g., such as shared information over the Internet including competitor's web pages), and servers of survey service providers, product sales specialist, and account managers.

Prior to calculating CDRT for a CDRT setting, such as CDRT setting associated with determining the CDRR, the CDRT module 182 can validate data integrity for Predicted MTBF (pMTBF) and Field MTBF (fMTBF). Validation of the data integrity verification process includes the CDRT module 182 or another module of the system reading pMTBF and fMTBF data to identify outliers by class. Classification of products or systems tested may include functionality type classes, form factor or complexity type classes, and market segment classes. Functionality type classes are associated with whether products or systems perform similar functions. Form factor or complexity type classes separate products and systems by size, location of use, or number of features, for example. Market segment classes may pertain to the quality of the product or service, such as whether it is high end or low end. Where there are outliers of a class, the CDRT module 182 or another module of the system remaps each affected product to an appropriate class. The CDRT module 182 can also validate that each product is mapped to the appropriate class, based on functionality, market served, operational environment, and form factor. CDRT module 182 may also communicate with product quality engineers via a computer for example, so that the engineers can review the data for errors.

Once data is deemed accurate by the CDRT module 182, another module, or an engineer, a CDRT setting computation can be performed by the CDRT module 182 or another module of the system. The computation may include searching for Customer Satisfaction CSAT scores for predecessors if product is problematic, such as customers are not satisfied with the product. The computation may also include determining a predetermined percentile, such as a 95th percentile, of pMTBF for the class. The computation may also include determining a predetermined percentile, such as a 95th percentile, of fMTBF for the class for a predetermined period of time, such as the last twelve months.

The CDRT setting computation may also include the CDRT module 182 or another module of the system obtaining a high availability MTBF (HA). The HA may be a maximum allowable downtime in a year, for a class. A default high availability minimum may be 100,000 hours for MTBF, for example. This may be the case where the default is for five 9's availability (99.999% availability).

The CDRT setting computation may also include the CDRT module 182 or another module of the system comparing customer annual return rate expectation against a maximum of high availability, pMTBF, and fMTBF, such as a 95th percentile pMTBF and 95th percentile fMTBF, and a computed target is determined according to the comparison. For example, a minimum of these two values (such as customer expectation or maximum of HA, pMTBF and fMTBF) is the computed target. The computed target may be rounded to the nearest higher predetermined amount of hours, such as being rounded to the nearest higher 10,000 hours.

The CDRT setting computation may also include the CDRT module 182 or another module of the system comparing the determined CDRT to competitive data, such as competitive intelligence data. Where customer reliability expectation is equal or below the determined reliability target, the customer reliability expectation is classified as a CDRT. Where customer reliability expectation is above the calculated reliability target, the calculated reliability data may be classified as the CDRT.

In one example, the following function ƒ(x) may be used to determine CDRTs for reliability classes and/or groupings of products.

ƒ(x)=Min[Max{HA MTBF, pMTBF, fMTBF}, Customer Ideal MTBF], Competitive, CSAT

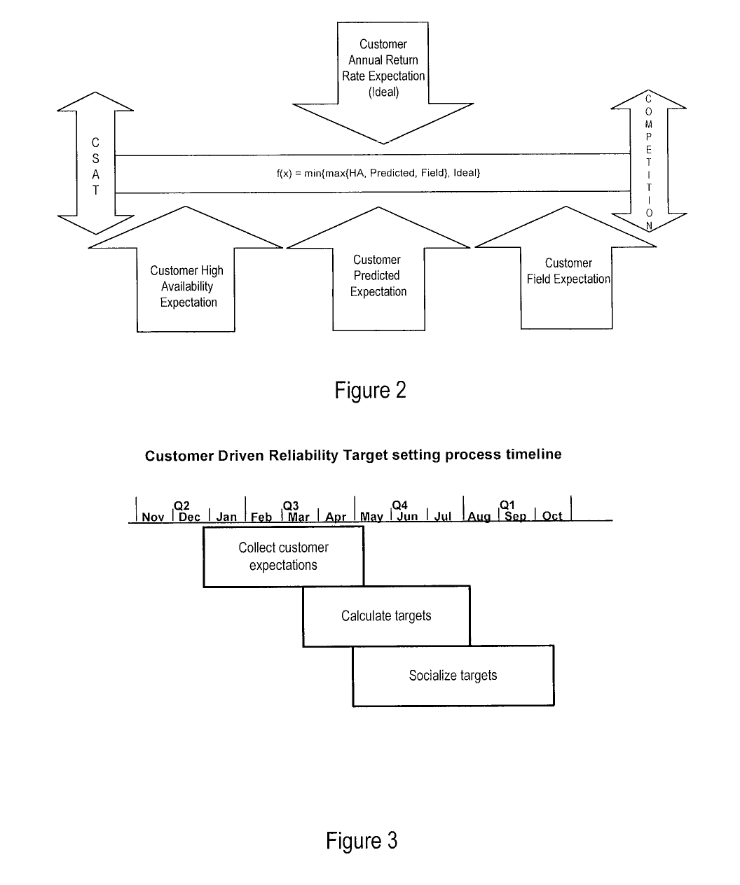

The CDRT is the larger of the three values HA, pMTBF and fMTBF, but not to exceed a Customer Ideal MTBF (customer ideal). The output of the function ƒ(x) is calibrated, such as annually calibrated, using competitive data, such as competitive intelligence data, and customer satisfaction (CSAT) scores. FIG. 2 illustrates the aspects of function ƒ(x). The various inputs shown in FIG. 2 include customer annual return rate expectation (e.g., customer ideal), HA, pMTBF, and fMTBF. One purpose of the customer ideal is to avoid over engineering. HA provides an expectation minimum of 99.999% platform, system, or network availability. pMTBF provides an expectation minimum based on historical prediction information. fMTBF provides an expectation minimum based on historical performance information.

In one example, CDRT must support an HA baseline, even if the baseline was initially architected for a higher end platform or product. This is due to most customer expectations falling into a preference for a higher end platform or product. In another example, the baseline is generated for a lower end platform or product but the CDRT must support an HA baseline. However, not supporting the HA baseline may be less significant because lower end platforms or products usually are more available and are less complex.

Availability, such as HA, can be expressed as a percentage. For example, availability of 99.999% is called “five nines” availability. Since there are roughly half a million minutes in a year, 99.999% availability translates into an unavailability of 10 per million or 5 minutes per half-million minutes or 5 minutes per year.

pMTBF may be calculated using an industry standard procedure such as Telcordia SR332 and may be quoted in marketing claims, data sheets, request for proposals (RFPs), and service level agreements (SLAB). In determining CDRT, pMTBF may be used as a factor because of its historical consistency. A predetermined percentile, such the fifth percentile, pMTBF can be computed for current products in each reliability class to determine a CDRT.

CDRT can use fMTBF as a factor because of its historical performance. Customers expect future releases or PIDs of same functionality to perform at least same or better than their predecessors. A predetermined percentile, such as fifth percentile, fMTBF can be computed for PIDs in each reliability class to determine a CDRT.

Customer expectations may be translated into MTBF hours. The customer ideal may serve as an upper control limit or a maximum value for a CDRT.

In addition, as mentioned, competitive information may be an inputted factor for determining CDRT. In some situations, competitive information can include limitations, such as scalability, reproducibility and reliability limitations. The system may compensate for such limitations by filtering the competitive information using various known filters, such as linear filters as used in signal processing or statistical analysis.

In addition, CDRT takes into account Customer Satisfaction (CSAT) information, which may be an inputted factor for determining CDRT, such as inputting results of a customer satisfaction survey. In some situations, CSAT information can include limitations, such as scalability, reproducibility and reliability limitations. The system may compensate for such limitations by filtering the CSAT information using various known filters, such as linear filters as used in signal processing and statistical analysis.

The CDRT module 182 or another module of the system can use the computed CDRTs in a socialization process. The socialization process includes analyzing new CDRTs and/or product reliability classes (PRCs) for a predetermined period of time, such as a next fiscal year, by product quality modules (such as one included in or associated with the RTS) configured for use by product quality engineers. If the CDRTs and/or PRCs have changed, the product quality modules socialize the CDRTs and/or PRCs with respective business unit modules and get their buy-in. Furthermore, CDRTs and/or PRCs can be reviewed via an integrated product team module (such as one included in or associated with the RTS). Also, CDRT goals and CDRR goals for a predetermined time period, may be reviewed via a quality management operating system. In one example, CDRTs are reviewed, validated, and reset, if desired, on a periodic basis, such as annually. New targets can be added for new product reliability classes and acquisitions. Scheduling for this target setting process is illustrated by FIG. 3.

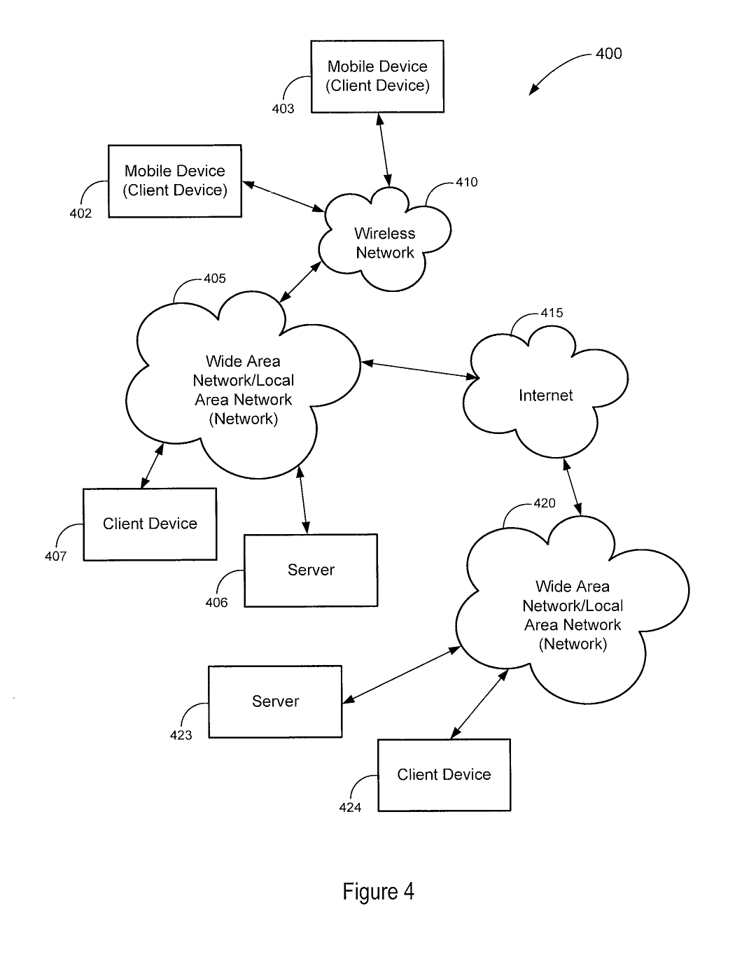

FIG. 4 illustrates a block diagram of an example architecture 400 for implementing an RTS. As shown, FIG. 4, for example, includes a variety of networks, such as a first local area network (LAN)/wide area network (WAN) 405 (e.g., a customer LAN/WAN) and wireless network 410, a variety of devices, such as client device 407 and mobile devices 402 and 403, and a variety of servers, such as server 406 (e.g., a server for hosting the various RTS modules such as the CDRT module 182). Further, the architecture 400 includes an intermediary network, such as the Internet 415, that connects the first LAN/WAN 405 to a second LAN/WAN 420 (e.g., a vendor LAN/WAN) that also includes a variety of devices (e.g., client device 424) and servers (e.g., a server 423 such as a server that provides one of the various inputs for the CDRT module 182). In certain exemplary embodiments, customers and partners of customers may only have access to the architecture 400 via devices of the first LAN/WAN 405 and the wireless network 410; whereas, a vendor(s) of the RTS may only have access to the RTS via devices of the second LAN/WAN 420. However, both the first LAN/WAN 405 and the second LAN/WAN 420 can share information and commands of the architecture 400 via the connections described herein. Although not depicted, the architecture 400 may also include mass storage and other LANs or WANs or any other form of area networks such as a metropolitan area network (MAN), a storage area network (SAN).

Regarding client devices, such as the mobile devices of FIG. 4, such devices may be used to collect customer information, such as survey data.

The architecture 400 may couple network components so that communications between such components can occur, whether communications are wire-line or wireless communications. Wire-line (such as a telephone line or coaxial cable) and wireless connections (such as a satellite link) can form channels that may include analog lines and digital lines. In communicating across such channels, the architecture 400 may utilize various architectures and protocols and may operate with a larger system of networks. Various architectures may include any variety or combination of distributed computing architectures, including, a 2-tier architecture (client-server architecture), an N-tier architecture, a peer-to-peer architecture, a tightly-coupled architecture, a service-oriented architecture (e.g., a cloud computing infrastructure), a mobile-code-based architecture, a replicated-repository-based architecture, and so forth. Further, the various nodes of the architecture 400 may provide configurations for differing architectures and protocols. For example, a router may provide a link between otherwise separate and independent LANs, and a network switch may connect two or more network devices or groups of network devices. Signaling formats or protocols employed may include, for example, Transmission Control Protocol/Internet Protocol (TCP/IP), User Datagram Protocol (UDP), or the like. In summary, the architecture 400 is only one example architecture that can support the RTS.

With respect to a wireless network, such as the wireless network 410, such a network may include stand-alone ad-hoc, mesh, Wireless LAN (WLAN), or a cellular network. A wireless network, such as network 410 may further include a system of terminals, gateways, switches, routers, call managers, and firewalls coupled by wireless radio links. A wireless network may further employ a plurality of network access technologies, including Global System for Mobile Communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, or 802.11b/g/n.

Networks (e.g., 405, 410, and 420) and devices (e.g., 402, 403, 406, 407, 423, and 424) of the architecture 400 may be or include computational nodes of the RTS. For example, the aspects of the architecture 400 can enable processing of different aspects of the RTS on a plurality of processors located at one or more of the computational nodes. A computational node may be one or more of any electronic device that can perform computations, such as a general-purpose computer, a mainframe computer, a workstation, a desktop computer, a laptop computer, a mobile device, and so forth. Computational nodes of the RTS may execute operations of the RTS such as the operation illustrated in FIGS. 1a, 1b, and 1c, or the computation illustrated in FIG. 2.

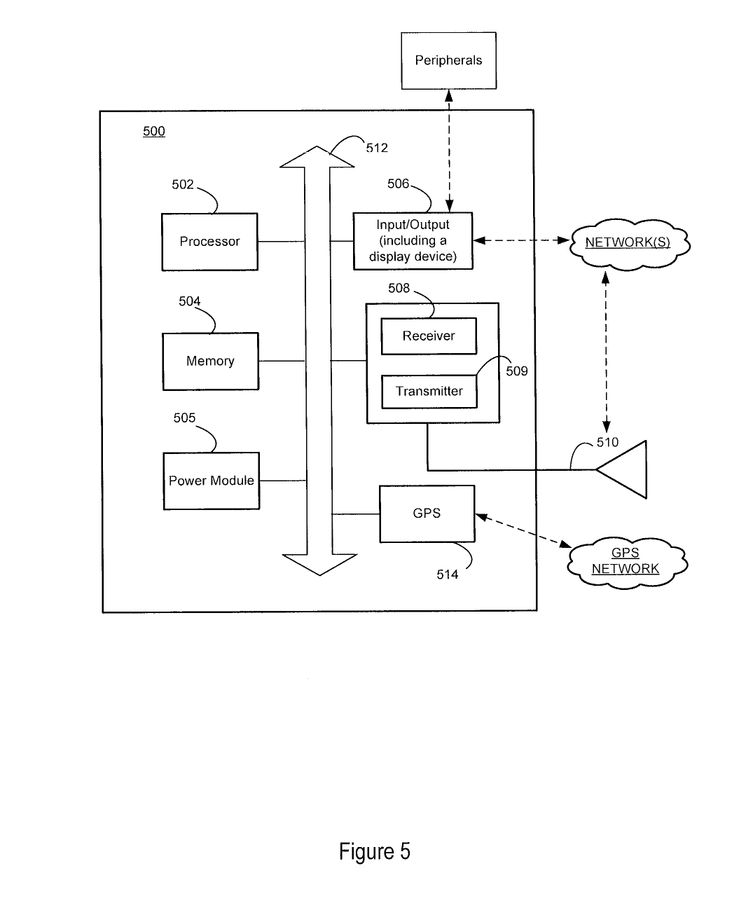

FIG. 5 illustrates a block diagram of an example electronic device 500 that can implement an aspect of an example RTS (e.g., an example RTS implemented by the architecture 400). Instances of the electronic device 500 may be any client device or server of the architecture 400 or any device capable of becoming a computational node of the RTS. The electronic device 500, which can be a combination of multiple electronic devices, may include a processor 502, memory 504, a power module 505, input/output (I/O) 506 (including input/out signals, one or more display devices, such as a display device to display the CDRT, sensors, and internal, peripheral, user, and network interfaces), a receiver 508 and a transmitter 509 (or a transceiver), an antenna 510 for wireless communications, a global positioning system (GPS) component 514, and a communication bus 512 that connects the aforementioned elements of the electronic device 500. The processor 502 can be one or more of any type of processing device, such as a central processing unit (CPU). Also, for example, the processor 502 can be central processing logic; central processing logic may include hardware and firmware, software, and/or combinations of each to perform function(s) or action(s), and/or to cause a function or action from another component. Also, based on a desired application or need, central processing logic may include a software controlled microprocessor, discrete logic such as an application specific integrated circuit (ASIC), a programmable/programmed logic device, memory device containing instructions, or the like, or combinational logic embodied in hardware. The memory 504, such as RAM or ROM, can be enabled by one or more of any type of memory device, such as a primary (directly accessible by the CPU) or a secondary (indirectly accessible by the CPU) storage device (e.g., flash memory, magnetic disk, optical disk). The power module 505 contains one or more power components, and facilitates supply and management of power to the electronic device 500. The input/output 506, can include any interface for facilitating communication between any components of the electronic device 500, components of external devices (such as components of other devices of the architecture 400), and users. For example, such interfaces can include a network card that is an integration of the receiver 508, the transmitter 509, and one or more I/O interfaces. The network card, for example, can facilitate wired or wireless communication with other nodes of the architecture 400. In cases of wireless communication, the antenna 510 can facilitate such communication. Also, the I/O interfaces, can include user interfaces such as monitors, displays, keyboards, keypads, touchscreens, microphones, and speakers. Further, some of the I/O interfaces and the bus 512 can facilitate communication between components of the electronic device, and in some embodiments ease processing performed by the processor 502. In other examples of the electronic device 500, one or more of the described components may be omitted.

Various embodiments described herein can be used alone or in combination with one another. The foregoing detailed description has described only a few of the many possible implementations of the present embodiments. For this reason, this detailed description is intended by way of illustration, and not by way of limitation.

Furthermore, the separating of example embodiments in operation blocks or modules described herein or illustrated in the drawings is not to be construed as limiting these blocks or modules as physically separate devices. Operational blocks or modules illustrated or described may be implemented as separate or combined devices, circuits, chips, or computer readable instructions.

Each module described herein is hardware, or a combination of hardware and software. For example, each module may include and/or initiate execution of an application specific integrated circuit (ASIC), a Field Programmable Gate Array (FPGA), a circuit, a digital logic circuit, an analog circuit, a combination of discrete circuits, gates, or any other type of hardware, or combination thereof. Accordingly, as used herein, execution of a module by a processor can also refer to logic based processing by the module that is initiated directly or indirectly by a processor to complete a process or obtain a result. Alternatively or in addition, each module can include memory hardware, such as at least a portion of a memory, for example, that includes instructions executable with a processor to implement one or more of the features of the module. When any one of the modules includes instructions stored in memory and executable with the processor, the module may or may not include the processor. In some examples, each module may include only memory storing instructions executable with a processor to implement the features of the corresponding module without the module including any other hardware. Because each module includes at least some hardware, even when the included hardware includes software, each module may be interchangeably referred to as a hardware module.

Each modules may include instructions stored in a non-transitory computer readable medium, such as memory 504 of FIG. 5, that may be executable by one or more processors, such as processor 502 of FIG. 5. Hardware modules may include various devices, components, circuits, gates, circuit boards, and the like that are executable, directed, or controlled for performance by the processor 502. Further, modules described herein may transmit or received data via communications interfaces via a network, such as or including the Internet. Also, the term “module” may include a plurality of executable modules.

What is claimed is:

1. A method, comprising:
receiving, via a communication interface communicatively coupled to a processor, a high availability mean time between failures (HA) of a product;
receiving, via the communication interface, a predicted mean time between failures (pMTBF) of the product;
receiving, via the communication interface, a field mean time between failures (fMTBF) according to historical customer experience information associated with the product;
determining, via the processor, a customer driven reliability target (CDRT) of a product according to the HA, the pMTBF, and the fMTBF, wherein the CDRT is a target reliability or quality score; and
outputting, via the processor, the CDRT to a display device to display the CDRT.

2. The method of claim 1, wherein the determining the CDRT comprises determining a maximum value between the HA, the pMTBF, and the fMTBF.

3. The method of claim 2, further comprising receiving, via the communication interface, a customer ideal mean time between failures (customer ideal) associated with the product, wherein the maximum value of the HA, the pMTBF, and the fMTBF is not to exceed the customer ideal.

4. The method of claim 1, further comprising:
receiving, via the communication interface, competitive intelligence information associated with the product; and
calibrating, via the processor, the CDRT using the competitive intelligence information.

5. The method of claim 1, further comprising:
determining, via the processor, a customer satisfaction score according to collected customer satisfaction information; and
calibrating, via the processor, the CDRT using the customer satisfaction score.

6. The method of claim 1, wherein the CDRT is a mean time between failures.

7. The method of claim 1, wherein the historical customer experience information includes historical product performance information associated with the product.

8. The method of claim 1, wherein the historical customer experience information includes historical customer satisfaction information associated with the product.

9. A method, comprising:
receiving, via a communication interface communicatively coupled to a processor, measured customer expectation information related to performance of a product and products competing with the product;
receiving, via the communication interface, predicted product performance information related to performance of the product and products competing with the product;
determining, via the processor, a customer driven reliability target (CDRT) according to the predicted product performance information and the measured customer expectation information, wherein the CDRT is a target reliability or quality score; and
outputting, via the processor, the CDRT to a display device to display the CDRT.

10. The method of claim 9, further comprising:
comparing, via the processor, the CDRT against current customer expectation information, wherein the current customer expectation information is customer expectation information collected within a predetermined amount of time from a present time; and
determining, via the processor, whether the customer driven reliability target exceeds the current customer expectation information by more than a predetermined threshold.

11. The method of claim 10, wherein the current customer expectation information is a mean time between failures.

12. The method of claim 10, wherein the predetermined threshold is a high availability mean time between failures.

13. The method of claim 9, wherein the predicted product performance information is a predicted mean time between failures (pMTBF).

14. The method of claim 9, wherein the measured customer expectation information includes historical customer experience information.

15. The method of claim 14, wherein the historical customer experience information includes historical product performance information associated with the product.

16. The method of claim 14, wherein the historical customer experience information includes historical customer satisfaction information associated with the product.

17. A system, comprising:
a non-transitory computer readable medium including:
instructions executable by a processor to select a high availability mean time between failures (HA) of a product;
instructions executable by a processor to determine a predicted mean time between failures (pMTBF) of the product;
instructions executable by a processor to determine a field mean time between failures (fMTBF) according to historical customer experience information associated with the product or a product competing with the product;
instructions executable by a processor to determine a customer driven reliability target (CDRT) of the product according to a maximum value between the HA, the pMTBF, and the fMTBF; and
instructions executable by a processor to output the CDRT to a display device to display the CDRT.

18. The system of claim 17, wherein the non-transitory computer readable medium further includes:
instructions executable by a processor to select a customer ideal mean time between failures (customer ideal), wherein the maximum value of the HA, the pMTBF, and the fMTBF is not to exceed the customer ideal;
instructions executable by a processor to identify customer satisfaction information associated with the product;
instructions executable by a processor to identify competitive intelligence information associated with the product; and
instructions executable by a processor to calibrate the CDRT using the customer satisfaction information and the competitive intelligence information.

19. The system of claim 17, wherein the historical customer experience information includes historical product performance information associated with the product.

20. The system of claim 17, wherein the historical customer experience information includes historical customer satisfaction information associated with the product.
